(19) United States
(12) Patent Application Publication
(10) Pub. No.: US 2024/0257067 A1
(43) Pub. Date: Aug. 1, 2024

(54) SCHEDULE MANAGEMENT APPARATUS, SCHEDULE MANAGEMENT METHOD, AND NON-TRANSITORY COMPUTER-READABLE STORAGE MEDIUM

(71) Applicant: NEC Corporation, Minato-ku, Tokyo (JP)

(72) Inventor: Kosuke NISHIHARA, Tokyo (JP)

(73) Assignee: NEC Corporation, Minato-ku, Tokyo (JP)

(21) Appl. No.: 18/290,851

(22) PCT Filed: Jul. 27, 2021
(86) PCT No.: PCT/JP2021/027684

§ 371 Date: Jan. 22, 2024

(51) Int. Cl. G06Q 10/1093

(52) U.S. Cl. CPC G06Q 10/1097

(57) ABSTRACT

A schedule management apparatus includes a schedule acquisition unit, an additional plan acquisition unit, and a plan addition unit (130). The schedule acquisition unit acquires schedule information of a target person. The additional plan acquisition unit acquires additional plan information indicating an additional plan to be added to the schedule information of the target person. The plan addition unit adds the additional plan to the schedule information by using the additional plan information. The schedule information includes at least one piece of already set plan information indicating an already set plan to be performed by the target person. When the already set plan and the additional plan overlap with each other on a time axis, the plan addition unit changes a start and end time of the already set plan in such a way that the already set plan and the additional plan do not overlap with each other.

### TECHNICAL FIELD

The present invention relates to a schedule management apparatus, a schedule management method, and a program.

### BACKGROUND ART

Patent Document 1 describes an apparatus as one example of an apparatus electronically managing a schedule of a person. The apparatus assigns a worker to a task such as maintenance of equipment. The apparatus stores information (task type) indicating whether a worker and/or a task time can be changed, for each of a plurality of the tasks. Then, when the same worker has tasks whose task times overlap with each other, the apparatus causes a graphic associated with the task of the task type indicating that such change can be made, to be displayed in a display area, with preference over a graphic associated with task information of the task type indicating that such change cannot be made.

Note that, Patent Document 2 discloses an apparatus that sets a display schedule of contents in a signage terminal. According to the document, a schedule mark indicating a display date and time of a content is arranged on a timeline by drag and drop. At this time, when the newly arranged schedule mark overlaps with an existing schedule mark, and when these two schedule marks have the same priority, a drop position of the schedule mark dropped this time is slid to an earlier side or a later side.

Further, Patent Document 3 discloses a print controlling apparatus that controls a printer connected to a network, and thereby causes the printer to process a printing job. When a certain job overlaps with an existing job as a result of changing a processing date and time of the certain job, the apparatus postpones a printing date and time of the existing job.

### RELATED DOCUMENT

### Patent Document

Patent Document 1: Japanese Patent Application Publication No. 2010-277484
Patent Document 2: Japanese Patent Application Publication No. 2013-186497
Patent Document 3: Japanese Patent Application Publication No. 2002-63004

### SUMMARY OF INVENTION

### Technical Problem

At a time of adding a new plan to a schedule, a plan has already been set in some case. One example of an object of the present invention is to enable a new plan to be added to a schedule, even when a plan has already been set, in a case of electronically managing the schedule of a person.

### Solution to Problem

According to one aspect of the present invention, there is provided a schedule management apparatus including:
a schedule acquisition unit that acquires schedule information of a target person;
an additional plan acquisition unit that acquires additional plan information indicating an additional plan to be added to the schedule information of the target person; and
a plan addition unit that adds the additional plan to the schedule information by using the additional plan information, in which
the schedule information includes at least one piece of already set plan information indicating an already set plan to be performed by the target person,
the already set plan information includes a start time and an end time of the already set plan,
the additional plan information includes a start time and an end time of the additional plan, and,
when the already set plan and the additional plan overlap with each other on a time axis, the plan addition unit changes the start time and the end time of the already set plan in such a way that the already set plan and the additional plan do not overlap with each other.

According to one aspect of the present invention, there is provided a schedule management method including,
by a computer, performing:
schedule acquisition processing of acquiring schedule information of a target person;
additional plan acquisition processing of acquiring additional plan information indicating an additional plan to be added to the schedule information of the target person; and
plan addition processing of adding the additional plan to the schedule information by using the additional plan information, in which
the schedule information includes at least one piece of already set plan information indicating an already set plan to be performed by the target person,
the already set plan information includes a start time and an end time of the already set plan, and
the additional plan information includes a start time and an end time of the additional plan,
the method further including, by the computer,
in the plan addition processing, when the already set plan and the additional plan overlap with each other on a time axis, changing the start time and the end time of the already set plan in such a way that the already set plan and the additional plan do not overlap with each other.

According to one aspect of the present invention, there is provided a program causing a computer to include:
a schedule acquisition function of acquiring schedule information of a target person;
an additional plan acquisition function of acquiring additional plan information indicating an additional plan to be added to the schedule information of the target person; and
a plan addition function of adding the additional plan to the schedule information by using the additional plan information, in which
the schedule information includes at least one piece of already set plan information indicating an already set plan to be performed by the target person,
the already set plan information includes a start time and an end time of the already set plan,
the additional plan information includes a start time and an end time of the additional plan, and,
when the already set plan and the additional plan overlap with each other on a time axis, the plan addition function changes the start time and the end time of the already set plan in such a way that the already set plan and the additional plan do not overlap with each other.

### Advantageous Effects of Invention

According to one aspect of the present invention, in a case of electronically managing a schedule of a person, a user can add a new plan to the schedule even when a plan has already been set

### BRIEF DESCRIPTION OF DRAWINGS

The above-described object, other objects, and features and advantages will become more apparent from the following preferred example embodiments and the following drawings associated therewith.

FIG. 1 It is a diagram illustrating one example of a functional configuration of a schedule management apparatus according to a first example embodiment.

FIG. 2 It is a diagram illustrating a first example of information stored by a storage unit.

FIG. 3 It is a diagram illustrating a second example of the information stored by the storage unit.

FIG. 4 It is a diagram illustrating an example of a hardware configuration of the schedule management apparatus.

FIG. 5 It is a flowchart illustrating one example of processing performed by the schedule management apparatus.

FIG. 6 It is a diagram for illustrating a first example of processing performed by a plan addition unit at a step S30 in FIG. 5.

FIG. 7 It is a diagram for illustrating the first example of the processing performed by the plan addition unit at the step S30 in FIG. 5.

FIG. 8 It is a diagram for illustrating a second example of the processing performed by the plan addition unit at the step S30 in FIG. 5.

FIG. 9 It is a diagram for illustrating the second example of the processing performed by the plan addition unit at the step S30 in FIG. 5.

FIG. 10 It is a diagram for illustrating a modified example of the second example.

FIG. 11 It is a diagram for illustrating a modified example of the second example.

FIG. 12 It is a diagram for illustrating a third example of the processing performed by the plan addition unit at the step S30 in FIG. 5.

FIG. 13 It is a diagram for illustrating a modified example of the third example.

FIG. 14 It is a diagram for illustrating a fourth example of the processing performed by the plan addition unit at the step S30 in FIG. 5.

FIG. 15 It is a diagram for illustrating a fifth example of the processing performed by the plan addition unit at the step S30 in FIG. 5.

FIG. 16 It is a diagram for illustrating the fifth example of the processing performed by the plan addition unit at the step S30 in FIG. 5.

FIG. 17 It is a diagram for illustrating a sixth example of the processing performed by the plan addition unit at the step S30 in FIG. 5.

FIG. 18 It is a diagram for illustrating a seventh example of the processing performed by the plan addition unit at the step S30 in FIG. 5.

FIG. 19 It is a diagram for illustrating an eighth example of the processing performed by the plan addition unit at the step S30 in FIG. 5.

FIG. 20 It is a diagram illustrating one example of the information stored by the storage unit in a second example embodiment.

### DESCRIPTION OF EMBODIMENTS

Hereinafter, example embodiments of the present invention will be described with reference to the drawings. Note that, similar constituent elements are denoted by similar reference signs in all the drawings, and description thereof will not be repeated as appropriate.

### First Example Embodiment

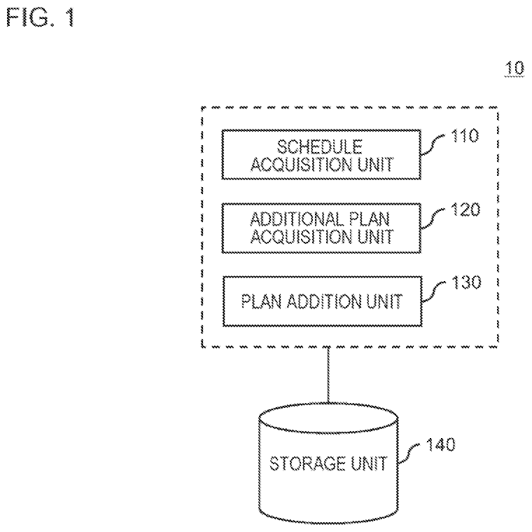

FIG. 1 is a diagram illustrating one example of a functional configuration of a schedule management apparatus 10 according to the present example embodiment. The schedule management apparatus 10 is an apparatus that manages a schedule of a person (hereinafter, referred to as a target person) as a management-target person. The target person performs one or more types of tasks. Among these types of tasks, at least one type of task can be carried out by any of plural target persons. One example of such tasks is home-visit nursing care. In this case, the tasks managed by the schedule include home-visit nursing care, training, intermission, and an office task. Further, the tasks as management-target tasks include at least one of home-visit nursing care, home-visit rehabilitation, home-visit medical treatment (e.g., medical treatment for an elderly person or a child), home-visit dentistry, housekeeping service, and home-visit repair and work for furniture, a home electric appliance, or the like. However, a person as the management-target person may be an office worker. In this case, a task managed by the schedule includes a meeting and a task that is performed by an individual person. Then, the schedule management apparatus 10 manages the schedule of these tasks.

The schedule management apparatus 10 includes a schedule acquisition unit 110, an additional plan acquisition unit 120, and a plan addition unit 130. Each of these functional units can use information stored in a storage unit 140. In the example illustrated in the present drawing, the storage unit 140 is a part of the schedule management apparatus 10, but may be located outside the schedule management apparatus 10.

The schedule acquisition unit 110 acquires schedule information of the target person. The schedule information includes information concerning a plan (hereinafter, referred to as an already set plan) that has already been set as a part of the schedule. This information includes at least plan identification information (e.g., a plan ID), a start time, and an end time of the already set plan. In the example illustrated in the present drawing, the schedule information is stored in the storage unit 140. Then, the schedule acquisition unit 110 acquires the schedule information from the storage unit 140.

The additional plan acquisition unit 120 acquires information (hereinafter, referred to as additional plan information) indicating an additional plan to be added to the schedule information. The additional plan information includes at least plan identification information of the additional plan, and a start time and an end time of the additional plan. In the example illustrated in the present drawing, the additional plan information is stored in the storage unit 140. Then, the additional plan acquisition unit 120 acquires the additional plan information from the storage unit 140.

The plan addition unit 130 adds the additional plan to the schedule information by using the additional plan information. At this time, when the already set plan and the additional plan overlap with each other on a time axis, the plan addition unit 130 changes the start time and the end time of the already set plan in such a way that the already set plan and the additional plan do not overlap with each other. Details of processing performed by the plan addition unit 130 will be described later with reference to other drawings.

The plan addition unit 130 causes the schedule indicated by the schedule information to be displayed on a display. A user of the schedule management apparatus 10 performs processing for adding the additional plan to the schedule while viewing the schedule displayed on the display. This processing is, for example, dragging and dropping, onto the schedule, a mark indicating the additional plan, in the display, but is not limited to this. For example, the user of the schedule management apparatus 10 may perform an operation for adding the additional plan to the schedule via a keyboard. For example, the user of the schedule management apparatus 10 may change the start time and the end time of at least one of the additional plan and the already set plan by operating the keyboard in such a way that the already set plan and the additional plan do not overlap with each other. When a start time and an end time of the additional plan have not been set, the user of the schedule management apparatus 10 may set a start time and an end time by operating the keyboard. At this time, the user of the schedule management apparatus 10 prevents the already set plan and the additional plan from overlapping with each other.

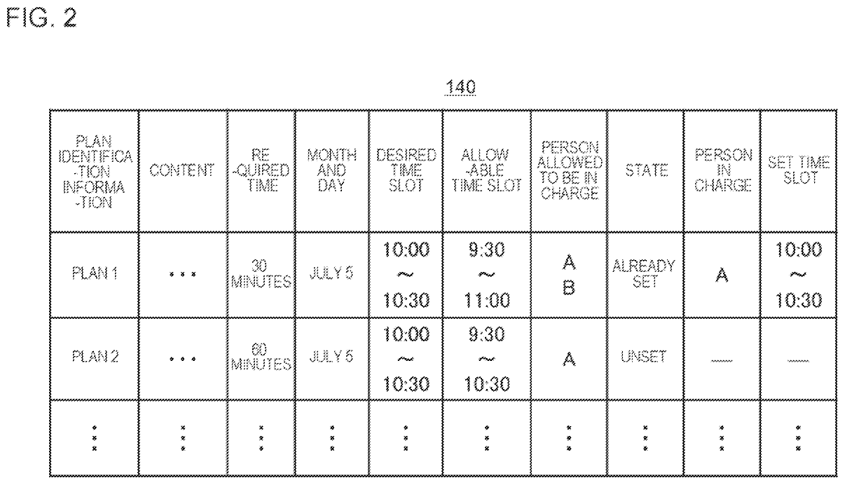

FIG. 2 is a diagram illustrating a first example of information stored in the storage unit 140. As illustrated in the present drawing, the storage unit 140 stores detailed information of the plan managed by the schedule management apparatus 10. The detailed information includes plan identification information, a content of a plan, a required time, a month and day on which the plan is to be done, a desired time slot of the plan, an allowable time slot of the plan, a target person (hereinafter, referred to as a person allowed to be in charge) who can be in charge of the plan, and a current state (e.g., whether the plan has already been set).

Examples of the above-described “content of the plan” includes a task name (e.g., home-visit nursing care, training, or an office task). When the plan is home-visit nursing care, the “content of the plan” further includes information determining a visit destination, and information indicating a task to be performed at the visit destination. Note that, the information determining the visit destination is associated with an address of the visit destination.

The above-described “desired time slot” indicates the first desired time slot of the plan. A length of the “desired time slot” is equal to a required time of the plan. The above-described “allowable time slot” indicates a time slot in which the plan is allowed to be set. A length of the “allowable time slot” is usually longer than the required time of the plan, but is equal to the required time in some case. In the latter case, the “allowable time slot” is equal to the “desired time slot”.

The detailed information concerning the already set plan further includes information determining a person in charge, and information indicating the time slot in which the plan has been set.

Then, the additional plan acquisition unit 120 acquires, as additional plan information, a part of the information illustrated in the present drawing.

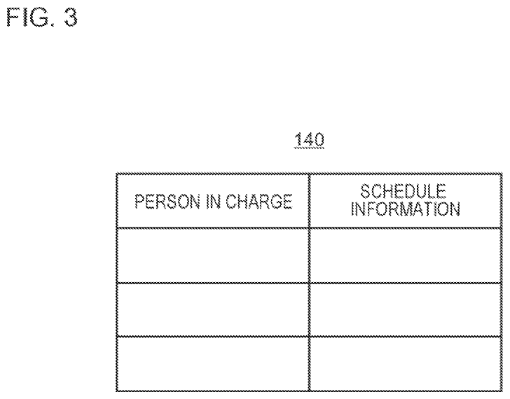

FIG. 3 is a diagram illustrating a second example of information stored in the storage unit 140. As illustrated in the present drawing, for each person in charge, the storage unit 140 stores schedule information of the person in charge. As described above, the schedule information includes at least plan identification information, a start time, and an end time of the already set plan.

Then, the schedule acquisition unit 110 reads out at least a part of the information illustrated in the present drawing. When the plan addition unit 130 uses detailed information of an already set plan, the schedule acquisition unit 110 reads out the detailed information that is among pieces of the information illustrated in FIG. 2 and that is associated with a plan ID of the already set plan.

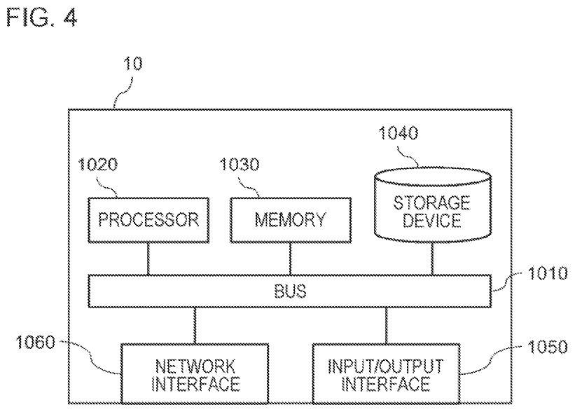

FIG. 4 is a diagram illustrating a configuration example of hardware of the schedule management apparatus 10. The schedule management apparatus 10 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to mutually transmit and receive data. However, a method of connecting the processor 1020 and the like to each other is not limited to bus connection.

The processor 1020 is a processor implemented by a central processing unit (CPU), a graphics processing unit (GPU), or the like.

The memory 1030 is a main storage apparatus implemented by a random access memory (RAM) or the like.

The storage device 1040 is an auxiliary storage apparatus implemented by a hard disk drive (HDD), a solid state drive (SSD), a memory card, a read only memory (ROM), or the like. The storage device 1040 stores a program module that implements each function (e.g., the schedule acquisition unit 110, the additional plan acquisition unit 120, and the plan addition unit 130) of the schedule management apparatus 10. When the processor 1020 reads each of these program modules onto the memory 1030, and executes the read program module, and thereby, each function associated with the program module is implemented. The storage device 1040 also functions as the storage unit 140.

The input/output interface 1050 is an interface for connecting the schedule management apparatus 10 and each type of input/output apparatus to each other. For example, the schedule management apparatus 10 communicates, via the input/output interface 1050, with an input device, such as a keyboard and a mouse, operated by a user of the schedule management apparatus 10.

The network interface 1060 is an interface for connecting the schedule management apparatus 10 to a network. The network is a local area network (LAN) or a wide area network (WAN), for example. A method in which the network interface 1060 makes connection to the network may be wireless connection or wired connection. The schedule management apparatus 10 may communicate, via the network interface 1060, with a portable terminal operated by a user of the schedule management apparatus 10.

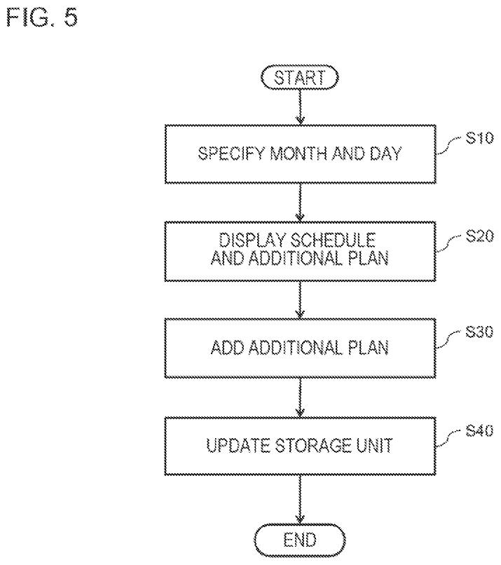

FIG. 5 is a flowchart illustrating one example of processing performed by the schedule management apparatus 10. Before the processing illustrated in the present drawing, the schedule information already includes an already set plan. For example, the schedule management apparatus 10 may incorporate a part of a plurality of plans into the schedule by processing the information stored in the storage unit 140 in accordance with a predetermined algorithm. Note that, work of incorporating the part of a plurality of the plans into the schedule may be performed by a user. In this case, the schedule management apparatus 10 incorporates the part of a plurality of the plans into the schedule in accordance with an input from the user. Then, the plan that has been incorporated into the schedule is set as an already set plan, and at least a part of the plans that have not been incorporated into the schedule is set as an additional plan.

Note that, at least a part of the additional plans may be an already set plan whose re-setting has become necessary, or may be a newly registered plan (e.g., a new plan that has been newly requested). In one example, in a case of the plan being home-visit nursing care, the already set plan is changed to an additional plan when inconvenience occurs at a visit destination or a person in charge suddenly needs to take a day off.

First, a user of the schedule management apparatus 10 inputs, to the schedule management apparatus 10, information specifying a month and day for which setting is to be made in the schedule (step S10). Then, the schedule acquisition unit 110 of the schedule management apparatus 10 acquires schedule information of the specified month and day from the storage unit 140. When the storage unit 140 stores schedule information of a plurality of target persons, the schedule acquisition unit 110 reads out the schedule information of a plurality of these target persons. The additional plan acquisition unit 120 of the schedule management apparatus 10 acquires, from the storage unit 140, as additional plan information, information concerning a plan that is among plans planned for the specified month and day and that has not been set. Then, the plan addition unit 130 causes a current schedule to be displayed on the display, and causes the additional plan information to be displayed on the display (step S20).

Note that, the user may further specify a time slot at the step S10. In this case, the schedule acquisition unit 110 and the additional plan acquisition unit 120 read out information of the specified month, day, and time slot at the step S20.

The user may further specify a target person at the step S10. In this case, the schedule acquisition unit 110 reads out schedule information of the specified target person at the step S20. At the step S20, the additional plan acquisition unit 120 reads out, from the storage unit 140, as an additional plan, a plan which is among unset plans and of which the specified target person can be in charge. The plan of which the target person can be in charge is a plan for which no person in charge is specified, and a plan whose specified persons in charge includes the person in charge.

Next, the user of the schedule management apparatus 10 performs, on the schedule management apparatus 10, an operation for adding the additional plan to the schedule. In accordance with this operation, the plan addition unit 130 of the schedule management apparatus 10 adds the additional plan to the schedule (step S30), and further updates the storage unit 140 (step S40). Details of the processing performed at the step S30 and the step S40 will be described later with reference to other drawings.

### First Operation Example

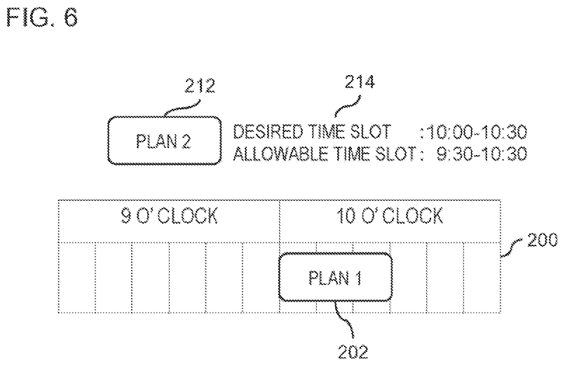

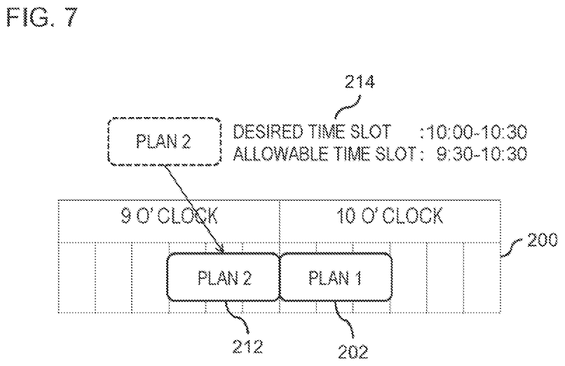

FIG. 6 and FIG. 7 are diagrams for illustrating a first example of the processing performed by the plan addition unit 130 at the step S30 in FIG. 5, and illustrate a screen of the display.

In the example illustrated in the present drawings, the plan addition unit 130 displays a schedule table 200 on the display, as illustrated in FIG. 6. The schedule table 200 includes an already set mark 202 indicating a time slot of an already set plan. A length of the already set mark 202 on a time axis is equal to a required time of the already set plan. A start point of the already set mark 202 indicates a start time of the already set plan, and an end point of the already set mark 202 indicates an end time of the already set plan.

A display mode (e.g., at least one of a color, a type of a frame line, and a type of hatching) of the already set mark 202 may be changed depending on a type (e.g., home-visit nursing care, training, an office task, or the like) of a plan indicated by the already set mark 202.

The plan addition unit 130 causes an addition mark 212 and a time slot display field 214 to be displayed, on the display, at positions that do not overlap with the schedule table 200. The addition mark 212 is a mark indicating an additional plan. The time slot display field 214 indicates an allowable time slot (i.e., second allowable time slot information) and a desired time slot of the additional plan. Thus, a user can easily recognize a time slot in which the additional plan is to be added, i.e., a position where the addition mark 212 is to be arranged.

Then, as illustrated in FIG. 7, the user of the schedule management apparatus 10 uses a mouse or the like, and thereby drags the addition mark 212 and moves the addition mark 212 in this state to a time slot which is in the schedule table 200 and at which the additional plan is desired to enter. At a time point when at least this movement starts, a length of the addition mark 212 on the time axis is equal to the required time of the additional plan. Note that, in a state illustrated in FIG. 6, a length of the addition mark 212 on the time axis may be equal to the required time of the additional plan.

After that, the user drops the addition mark 212. Then, the plan addition unit 130 incorporates the additional plan into the time slot which is included in the schedule table 200 and to which the drop has been made. In this state, a start point and an end point of the addition mark 212 coincide with a start time and an end time of the additional plan, respectively.

At this time, the already set plan and the additional plan overlap with each other on the time axis in some case. In this case, the plan addition unit 130 changes the start time and the end time of the already set plan in such a way that the already set plan and the additional plan do not overlap with each other.

Note that, in some case, a blank time having a predetermined length needs to be provided between the already set plan (e.g., the plan 1 in FIG. 6 and FIG. 7) and the additional plan (e.g., the plan 2 in FIG. 6 and FIG. 7). As one example thereof, there is a case in which a location where the already set plan is performed is different from a location of the additional plan, and a travel time needs to be secured. In this case, at the time of changing the start time and the end time of the already set plan, the plan addition unit 130 provides a blank time having a predetermined length between the already set plan and the additional plan. The length of the blank time may be a fixed value, or may be decided by using detailed information of the already set plan and the additional plan. For example, when the detailed information includes an address of the location where each plan is performed, the plan addition unit 130 uses these two addresses, and thereby decides the length of the blank time. In one example, the plan addition unit 130 determines a route connecting these two locations, and sets a time required for traveling the route, as the minimum value of the length of the blank time. This processing is implemented by using a navigation technique, for example.

Then, the plan addition unit 130 updates the storage unit 140 at the step S40 in FIG. 5. Specifically, the plan addition unit 130 changes, from “unset” to “already changed”, a state associated with the additional plan that has been incorporated into the schedule table 200 this time. The plan addition unit 130 causes information indicating a target person of this time to be stored in the “person in charge” associated with the incorporated additional plan, and causes the time slot (i.e., the start time and the end time of the additional plan) in which the addition mark 212 has been dropped, to be stored in the “set time slot” associated with the incorporated additional plan.

When the plan addition unit 130 has changed the start time and the end time of the already set plan, the plan addition unit 130 updates the times associated with the already set plan in the information stored in the storage unit 140 to changed times.

### Second Operation Example

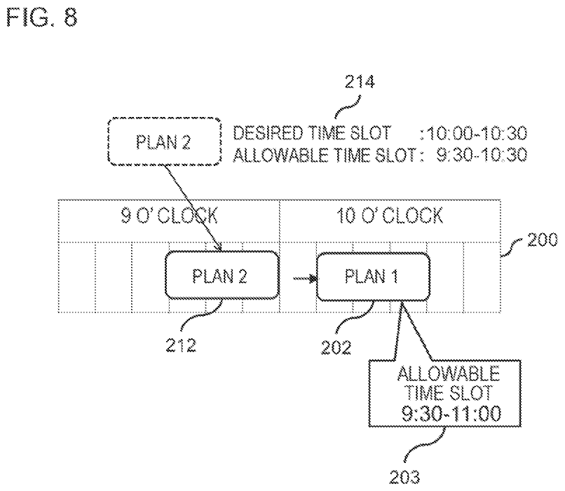

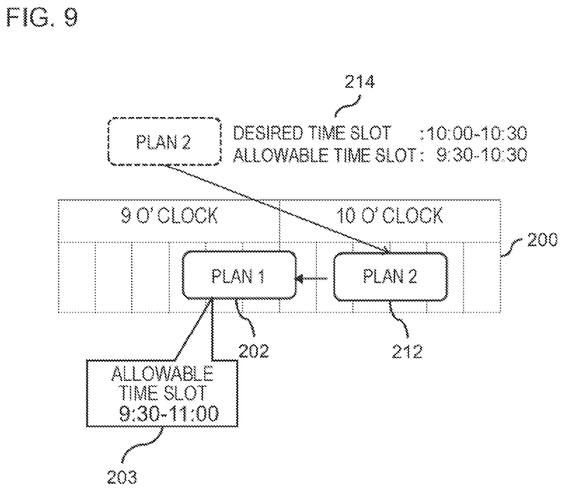

FIG. 8 and FIG. 9 are diagrams for illustrating a second example of the processing performed by the plan addition unit 130 at the step S30 in FIG. 5, and illustrate a screen of the display. In the example illustrated in the present drawings, when the already set plan and the additional plan overlap with each other on the time axis, the plan addition unit 130 decides whether to shift the already set plan to an earlier side or a later side, by using a position (e.g., a position of the addition mark 212) where the additional plan is to be added in the schedule table 200, or using a transition of the position.

For example, as illustrated in FIG. 8, when the addition mark 212 enters before the already set plan on the time axis, the plan addition unit 130 shifts the already set plan to a later side. As illustrated in FIG. 9, when the addition mark 212 enters after the already set plan on the time axis, the plan addition unit 130 shifts the already set plan to an earlier side. Here, a change amount of the time slot of the already set plan is proportional to an amount by which by the addition mark 212 pushes the already set mark 202. In other words, in the schedule table 200, each time the addition mark 212 moves in a direction approaching the already set mark 202, the already set mark 202 also moves in a direction separating from the addition mark 212. In this manner, the user of the schedule management apparatus 10 can easily change the time slot of the already set plan as the user intends.

Here, when the plan addition unit 130 has shifted (or starts to shift) the time slot of the already set plan, the plan addition unit 130 may cause the display or a speaker to output a warning that indicates this shifting.

When the plan addition unit 130 has shifted (or starts to shift) the time slot of the already set plan, the plan addition unit 130 may provide a time slot display field 203 that represent a text indicating an allowable time slot of the already set plan. In this case, the plan addition unit 130 reads out the allowable time slot of the already set plan from the storage unit 140. For example, the time slot display field 203 is a balloon, a pop-up, or the like. Note that, the plan addition unit 130 may cause a desired time slot of the already set plan to be further displayed in the time slot display field 203.

Here, when the schedule table 200 includes a plurality of already set plans, the plan addition unit 130 may provide the time slot display fields 203 for all the already set plans, or may provide the time slot display field 203 for a part (e.g., the already set plan selected by the user of the schedule management apparatus 10) of the already set plans.

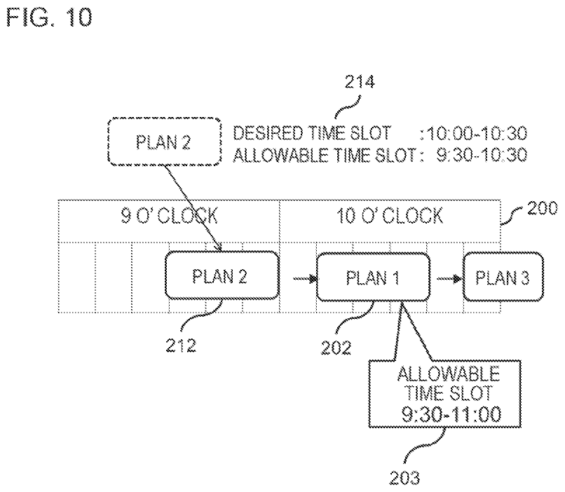

Note that, as illustrated in FIG. 10, as a result of changing the time slot of the already set plan (the plan 1 in FIG. 9), the time slot of this already set plan overlaps with a different already set plan (the plan 3 in FIG. 9) in some case. In this case, the plan addition unit 130 shifts a start time and an end time of the above-described different already set plan in such a way that these two plans do not overlap with each other. A relation between the plan 1 and the plan 3 at this time is the same as the relation between the plan 2 and the plan 1.

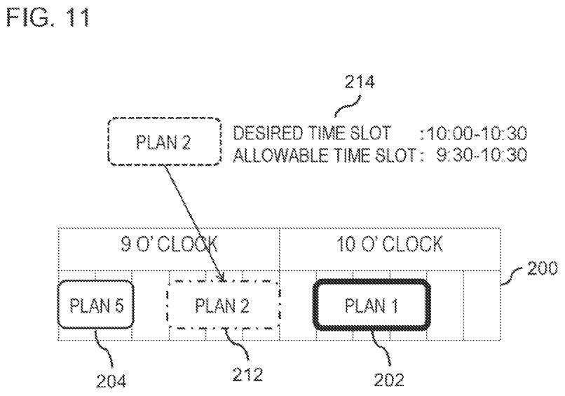

As illustrated in FIG. 11, the plan addition unit 130 may cause the addition mark 212 to be displayed in a mode different from any of the marks (e.g., the already set marks 202 and 204) indicating the already set plans included in the schedule table 200. In this manner, the user of the schedule management apparatus 10 can easily recognize the additional plan that is included in the schedule table 200 and that has been added this time. The plan addition unit 130 may cause the already set mark 202 whose time slot has been changed this time, to be displayed in a mode different from that of the already set mark 204 of the different already set plan. In this manner, the user of the schedule management apparatus 10 can easily recognize the already set plan that is included in the schedule table 200 and whose time slot has been changed this time.

### Third Operation Example

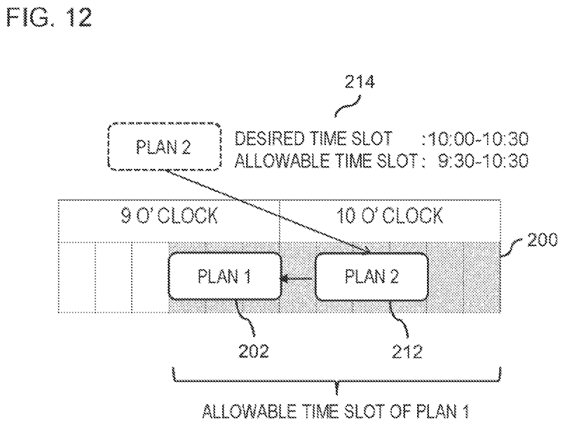

FIG. 12 is a diagram for illustrating a third example of the processing performed by the plan addition unit 130 at the step S30 in FIG. 5, and illustrates a screen of the display. The example illustrated in the present drawing is similar to the first example or the second example described above, except for the following points.

First, the plan addition unit 130 reads out an allowable time slot of an already set plan, from the storage unit 140. Then, the plan addition unit 130 causes the allowable time slot of the already set plan to be displayed in the schedule table 200, in a mode different from that of a different time slot. In this manner, the user of the schedule management apparatus 10 can easily recognize a range in which the already set plan can be changed on the time axis. The plan addition unit 130 may perform such displaying when the plan addition unit 130 has shifted (or starts to shift) the time slot of the already set plan. The plan addition unit 130 may perform such displaying, concerning the already set plan associated with the specific already set mark 202 when this already set mark 202 is selected.

The plan addition unit 130 changes a start time and an end time of the already set plan within the allowable time slot of the already set plan. For example, in the example illustrated in FIG. 11, the plan addition unit 130 shifts the already set plan to an earlier side, but does not set the start time of the already set plan before a start time of the allowable time slot. This manner can suppress the user from deviating the already set plan from the allowable time slot of the already set plan.

### Modified Example of Third Operation Example

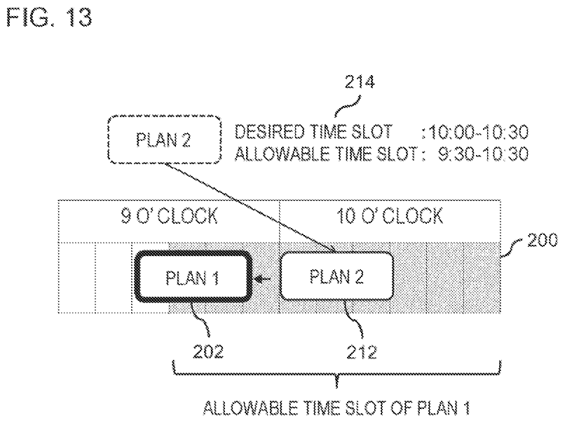

FIG. 13 is a diagram for illustrating a modified example of the third example described with reference to FIG. 12. In the example illustrated in the present drawing, the plan addition unit 130 can change at least one of a start time and an end time of an already set plan to a time outside an allowable time slot of the already set plan. However, in this case, the plan addition unit 130 causes information indicating this changing to be displayed on the display.

In the example illustrated in the present drawing, the plan addition unit 130 causes an addition mark 212 of the already set plan whose time slot is at least partially outside the allowable time slot, to be displayed in a mode different from that of a different already set plan 212. One example of the different mode is highlighting. The highlighting is making an outer frame of the set mark 202 thicker, changing a color of at least one of the outer frame and an inside of the frame, adding a predetermined pattern to the inside of the frame, or the like, for example, but is not limited to these.

Note that, for example, the schedule addition unit 130 may cause an expression indicating that at least a part of the time slot of the already set plan is made to be outside the allowable time slot, to be displayed on the display by a pop-up, a balloon, or the like.

### Fourth Operation Example

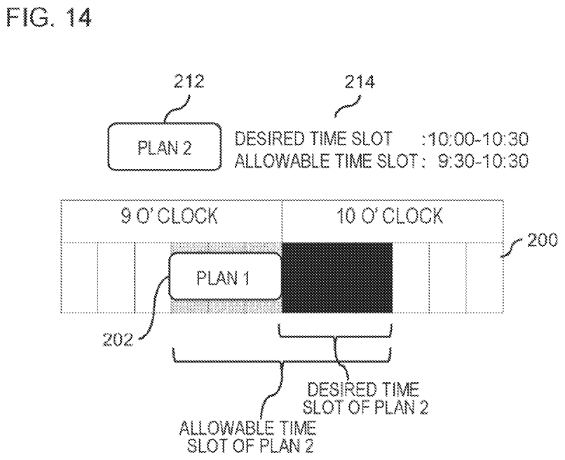

FIG. 14 is a diagram for illustrating a fourth example of the processing performed by the plan addition unit 130 at the step S30 in FIG. 5, and illustrates a screen of the display. The example illustrated in the present drawing is similar to any one of the above-described examples, except for the following points.

In the example illustrated in the present drawing, the plan addition unit 130 causes an allowable time slot included in the schedule table 200 and concerning an additional plan (e.g., the plan 2), to be displayed in a mode different from those of the other time slots. The plan addition unit 130 causes a desired time slot included in the schedule table 200 and concerning the additional plan, to be displayed in a mode different from that of the allowable time slot of the additional plan and those of the other time slots. In this manner, the user of the schedule management apparatus 10 can recognize the allowable time slot and the desired time slot of the additional plan by simply viewing the schedule table 200.

### Fifth Operation Example

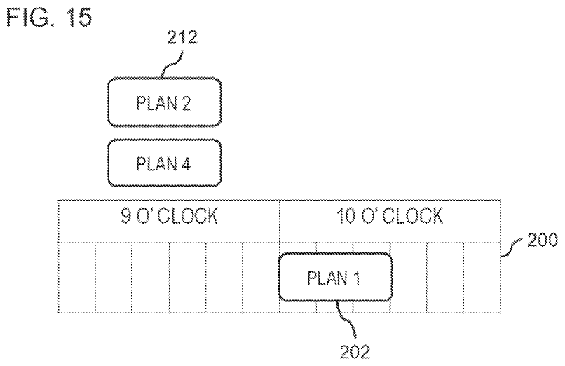

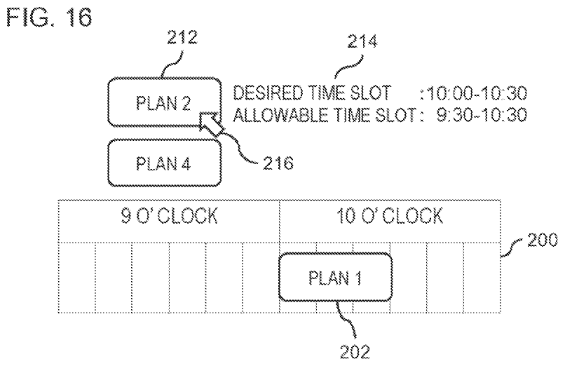

FIG. 15 and FIG. 16 are diagrams for illustrating a fifth example of the processing performed by the plan addition unit 130 at the step S30 in FIG. 5, and illustrates a screen of the display. The example illustrated in the present drawing is similar to any one of the above-described examples, except for the following points.

First, the additional plan acquisition unit 120 acquires additional plan information of each of a plurality of additional plans. Then, as illustrated in FIG. 15, the plan addition unit 130 causes an addition mark 212 associated with each of a plurality of these additional plans to be displayed on the display together with the schedule table 200. However, the plan addition unit 130 does not cause time slot display fields 214 of any of the additional plans to be displayed.

Then, as illustrated in FIG. 16, when the user of the schedule management apparatus 10 selects one of the addition marks 212 (e.g., by using a cursor 216), the plan addition unit 130 causes the time slot display field 214 associated with the selected addition mark 212 to be displayed. This manner prevents the user of the schedule management apparatus 10 from mistaking an allowable time slot and a desired time slot of the additional schedule about to be added, for an allowable time slot and a desired time slot of the different additional plan.

### Sixth Operation Example

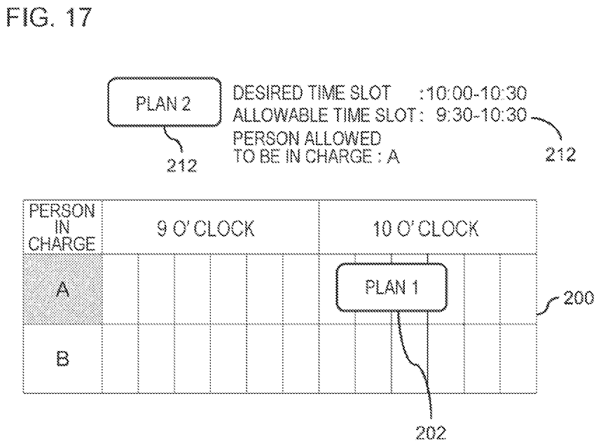

FIG. 17 is a diagram for illustrating a sixth example of the processing performed by the plan addition unit 130 at the step S30 in FIG. 5, and illustrates a screen of the display. The example illustrated in the present drawing is similar to any one of the above-described examples, except for the following points.

First, the schedule acquisition unit 110 acquires schedule information of each of a plurality of target persons (depicted as person in charge in FIG. 17). Then, the plan addition unit 130 causes schedules of a plurality of these target persons to be displayed as a list in the schedule table 200.

As indicated by the addition mark 212, an additional plan is associated with information indicating a person allowed to be in charge. The plan addition unit 130 causes the information indicating the person allowed to be in charge, to be displayed in the schedule table 200 on the screen of the display. In one example, the plan addition unit 130 adds a predetermined mark or a predetermined color or hatching to a field included in the schedule table 200 and corresponding to the person allowed to be in charge, or highlights a frame of this field. In this manner, the user of the schedule management apparatus 10 can easily recognize the current schedule of the person allowed to be in charge.

Note that, the plan addition unit 130 may prevent the addition mark 212 from being placed in any field of the schedule table 200 other than the person allowed to be in charge.

### Seventh Operation Example

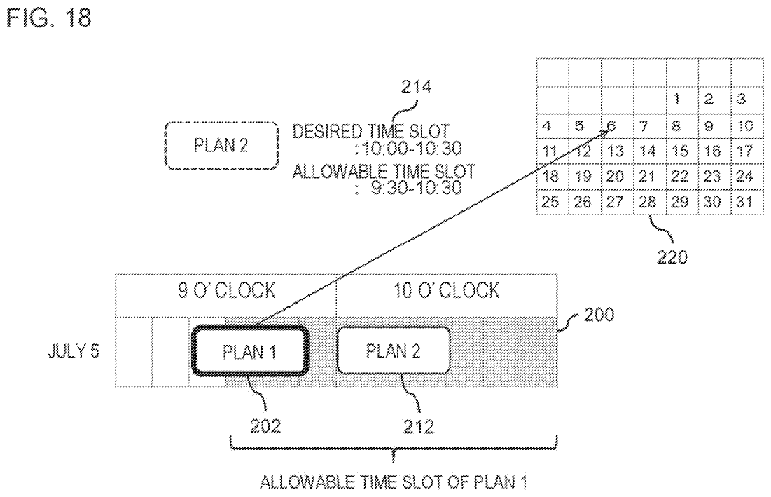

FIG. 18 is a diagram for illustrating a seventh example of the processing performed by the plan addition unit 130 at the step S30 in FIG. 5, and illustrates a screen of the display. The example illustrated in the present drawing is similar to any one of the above-described examples, except for the following points.

First, the plan addition unit 130 causes a calendar display field 220 to be displayed on the display together with the schedule table 200, the addition mark 212, and the time slot display field 214. The calendar display field 220 displays a calendar of the month targeted by the schedule table 200. When the user of the schedule management apparatus 10 drags and drops at least one of the already set mark 202 and the addition mark 212 onto a predetermined day in the calendar display field 220, the plan addition unit 130 changes the plan associated with the mark, to the additional plan at the day onto which the drag and drop is performed. The plan addition unit 130 updates the storage unit 140 according to a result of this changing. In this manner, the user can easily change a day on which the plan is to be performed.

Here, when the user of the schedule management apparatus 10 drags the already set mark 202 or the addition mark 212, the plan addition unit 130 may recognize an allowable time slot (or a desired time slot) of the additional plan, and may cause a day that is included in the calendar display field 220 and on which the allowable time slot (or the desired time slot) is vacant, to be displayed (e.g., highlighted) in a mode different from that of different days. In this manner, the user can easily recognize the day to which the dragged plan is to be added.

### Eighth Operation Example

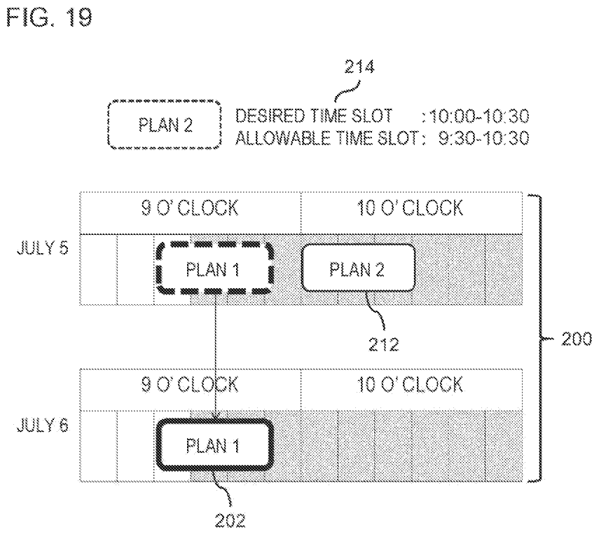

FIG. 19 is a diagram for illustrating an eighth example of the processing performed by the plan addition unit 130 at the step S30 in FIG. 5, and illustrates a screen of the display. The example illustrated in the present drawing is similar to any one of the above-described examples, except for the following points.

The plan addition unit 130 causes the schedule tables 200 of a plurality of days to be displayed simultaneously on the screen. At this time, time axes of a plurality of the schedule tables 200 preferably coincide with each other. In the example illustrated in the present drawing, the time axes are oriented in a lateral direction. In the lateral direction, the same time (e.g., ten o'clock) of each of a plurality of the schedule tables 200 is at the same location.

Then, the user moves the already set mark 202 included in the schedule table 200 of the certain day to the schedule table 200 of the different day by drag and drop, for example. Then, the plan addition unit 130 changes the already set plan indicated by the already set mark 202, to the already set plan of a date and time at the movement destination. The plan addition unit 130 reflects this changing also in the storage unit 140. In this manner, the user can easily change a date and time of the already set plan.

As described above, according to the present example embodiment, a user of the schedule management apparatus 10 can easily add a new plan to a schedule even when an already set plan exists.

### Second Example Embodiment

The schedule management apparatus 10 according to the present example embodiment is similar to the schedule management apparatus 10 according to the first example embodiment, except that a time slot of at least one already set plan cannot be changed.

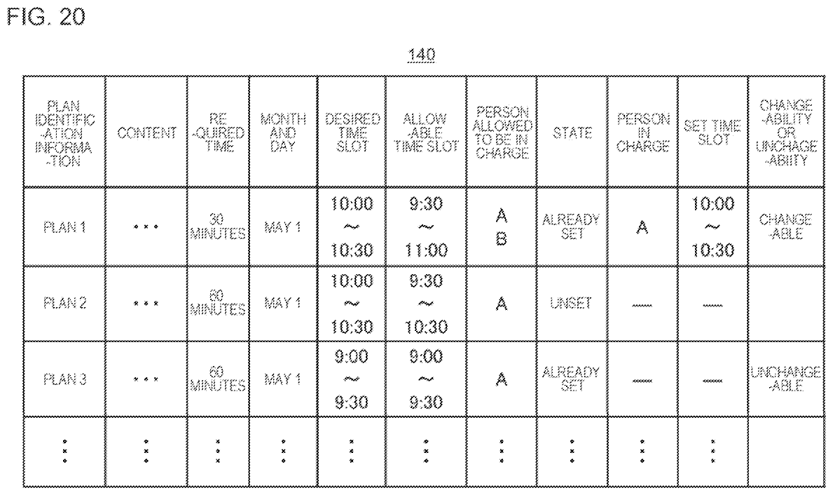

FIG. 20 illustrates one example of information stored by the storage unit 140 in the present example embodiment, and is associated with FIG. 2 of the first example embodiment. The storage unit 140 illustrated in the present drawing is similar to that of the example illustrated in FIG. 2, except that the storage unit 140 further stores changeability-unchangeability information concerning a plan of which the state indicates being already set.

The changeability-unchangeability information indicates whether or not a time slot of the plan is allowed to be changed, and is set by a user of the schedule management apparatus 10, for example. For example, the user makes the setting in such a way that an important plan is unchangeable. Then, when the schedule acquisition unit 110 reads out the schedule information, the schedule acquisition unit 110 reads out also the changeability-unchangeability information. When the plan addition unit 130 adds an additional plan to the schedule, the plan addition unit 130 does not change a time slot of the already set plan that is unchangeable in the changeability-unchangeability information.

Also according to the present example embodiment, a user of the schedule management apparatus 10 can easily add a new plan to a schedule even when an already set plan exists. At this time, a time slot of an important plan can be restrained from being changed.

Although the example embodiments of the present invention are described above with reference to the drawings, these are exemplifications of the present invention, and various configurations other than those described above can also be adopted.

Although a plurality of the steps (pieces of processing) are described in order in a plurality of the flowcharts used in the above description, the execution order of the steps executed in each example embodiment is not limited to the described order. In each example embodiment, the order of the illustrated steps can be changed within a range in which inconvenience does not occur in the content. The above-described each example embodiment can be combined within a range in which contradiction does not occur in the content.

A part or all of the above-described example embodiments can also be described as in the following supplementary notes, but there is no limitation to the following.

1. A schedule management apparatus including:
a schedule acquisition unit that acquires schedule information of a target person;
an additional plan acquisition unit that acquires additional plan information indicating an additional plan to be added to the schedule information of the target person; and
a plan addition unit that adds the additional plan to the schedule information by using the additional plan information, in which
the schedule information includes at least one piece of already set plan information indicating an already set plan to be performed by the target person,
the already set plan information includes a start time and an end time of the already set plan,
the additional plan information includes a start time and an end time of the additional plan, and,
when the already set plan and the additional plan overlap with each other on a time axis, the plan addition unit changes the start time and the end time of the already set plan in such a way that the already set plan and the additional plan do not overlap with each other.
   2. The schedule management apparatus according to supplementary note 1, in which
the already set plan information includes allowable time slot information indicating a time slot in which the already set plan is allowed to be set, and
the plan addition unit changes the start time and the end time of the already set plan within the time slot indicated by the allowable time slot information.
   3. The schedule management apparatus according to supplementary note 1, in which
the already set plan information includes first allowable time slot information indicating a time slot in which the already set plan is allowed to be set, and,
when at least one of the start time and the end time of the already set plan after change is outside the time slot indicated by the first allowable time slot information, the plan addition unit outputs information having an indication thereof.
   4. The schedule management apparatus according to supplementary note 2 or 3, in which
the plan addition unit causes the time slot in which the already set plan is allowed to be set, to be displayed on a display.
   5. The schedule management apparatus according to any one of supplementary notes 1 to 4, in which
the additional plan information includes second allowable time slot information indicating a time slot in which the additional plan is allowed to be set, and desired time slot information indicating a desired time slot of the additional plan, and
the plan addition unit causes a schedule indicated by the schedule information to be displayed on a screen, and also causes each of the time slot indicated by the second allowable time slot information and the desired time slot, to be visually recognizable in the schedule.
   6. The schedule management apparatus according to any one of supplementary notes 1 to 5, in which
the plan addition unit
   causes a schedule indicated by the schedule information to be displayed on a screen, and
   causes the additional plan to be displayed in the screen in a mode different from that of the already set plan included in the schedule, and also causes the already set plan whose start time and end time have been changed, to be displayed in the screen in a mode different from that of a different already set plan.
      7. The schedule management apparatus according to any one of supplementary notes 1 to 6, in which
the plan addition unit
   causes a schedule indicated by the schedule information to be displayed on a screen,
   determines a position where the additional plan is to be added in the schedule within the screen, based on an operation performed by a user of the schedule management apparatus, and
   decides whether to shift the already set plan to an earlier side or a later side, by using the position or a transition of the position, when the already set plan and the additional plan overlap with each other on a time axis.
      8. The schedule management apparatus according to supplementary note 7, in which
the operation is to drag and drop a mark indicating the additional plan, and,
when the already set plan and the additional plan overlap with each other on a time axis, the plan addition unit
   shifts the already set plan to a later side when the mark enters before the already set plan, and
   shifts the already set plan to an earlier side when the mark enters after the already set plan.
      9. The schedule management apparatus according to any one of supplementary notes 1 to 8, in which
the plan addition unit provides a blank time having a predetermined length between the additional plan and the already set plan.
   10. The schedule management apparatus according to supplementary note 9, in which
the plan addition unit
   acquires detailed information indicating at least one of a location and an action, concerning at least one of the additional plan and the already set plan, and
   decides the predetermined length by using the detailed information.
      11. The schedule management apparatus according to any one of supplementary notes 1 to 10, in which
the schedule acquisition unit acquires the schedule information of each of a plurality of the target persons,
the additional plan information includes information indicating the target person allowed to be in charge of the additional plan, and
the plan addition unit
   causes a schedule indicated by the schedule information of each of the plurality of target persons, to be displayed in a screen,
   determines a position where the additional plan is to be added in the screen, based on an operation performed by a user of the schedule management apparatus, and
   causes information indicating the target person allowed to be in charge of the additional plan, to be displayed in the screen.
      12. A schedule management method including,
by a computer, performing:
schedule acquisition processing of acquiring schedule information of a target person;
additional plan acquisition processing of acquiring additional plan information indicating an additional plan to be added to the schedule information of the target person; and
plan addition processing of adding the additional plan to the schedule information by using the additional plan information, in which
the schedule information includes at least one piece of already set plan information indicating an already set plan to be performed by the target person,
the already set plan information includes a start time and an end time of the already set plan, and
the additional plan information includes a start time and an end time of the additional plan,
the method further including, by the computer,
in the plan addition processing, when the already set plan and the additional plan overlap with each other on a time axis, changing the start time and the end time of the already set plan in such a way that the already set plan and the additional plan do not overlap with each other.
   13. The schedule management method according to supplementary note 12, in which
the already set plan information includes allowable time slot information indicating a time slot in which the already set plan is allowed to be set,
the method further including, by the computer,
in the plan addition processing, changing the start time and the end time of the already set plan within the time slot indicated by the allowable time slot information.
   14. The schedule management method according to supplementary note 12, in which
the already set plan information includes first allowable time slot information indicating a time slot in which the already set plan is allowed to be set,
the method further including, by the computer,
in the plan addition processing, when at least one of the start time and the end time of the already set plan after change is outside the time slot indicated by the first allowable time slot information, outputting information having an indication thereof.
   15. The schedule management method according to supplementary note 13 or 14, further including, by the computer,
in the plan addition processing, causing the time slot in which the already set plan is allowed to be set, to be displayed on a display.
   16. The schedule management method according to any one of supplementary notes 12 to 15, in which
the additional plan information includes second allowable time slot information indicating a time slot in which the additional plan is allowed to be set, and desired time slot information indicating a desired time slot of the additional plan,
the method further including, by the computer,
in the plan addition processing, causing a schedule indicated by the schedule information to be displayed on a screen, and also causing each of the time slot indicated by the second allowable time slot information and the desired time slot, to be visually recognizable in the schedule.
   17. The schedule management method according to any one of supplementary notes 12 to 16, further including, by the computer,
in the plan addition processing:
causing a schedule indicated by the schedule information to be displayed on a screen; and
causing the additional plan to be displayed in the screen in a mode different from that of the already set plan included in the schedule, and also causing the already set plan whose start time and end time have been changed, to be displayed in the screen in a mode different from that of a different already set plan.
   18. The schedule management method according to any one of supplementary notes 12 to 17, further including, by the computer,
in the plan addition processing:
causing a schedule indicated by the schedule information to be displayed on a screen;
determining a position where the additional plan is to be added in the schedule within the screen, based on an operation performed by a user of the schedule management method; and
deciding whether to shift the already set plan to an earlier side or a later side, by using the position or a transition of the position, when the already set plan and the additional plan overlap with each other on a time axis.
   19. The schedule management method according to supplementary note 18, in which
the operation is to drag and drop a mark indicating the additional plan,
the method further including, by the computer,
in the plan addition processing, when the already set plan and the additional plan overlap with each other on a time axis;
shifting the already set plan to a later side when the mark enters before the already set plan; and
shifting the already set plan to an earlier side when the mark enters after the already set plan.
   20. The schedule management method according to any one of supplementary notes 12 to 19, further including, by the computer,
in the plan addition processing, providing a blank time having a predetermined length between the additional plan and the already set plan.
   21. The schedule management method according to supplementary note 20, further including, by the computer,
in the plan addition processing:
acquiring detailed information indicating at least one of a location and an action, concerning at least one of the additional plan and the already set plan; and
deciding the predetermined length by using the detailed information.
   22. The schedule management method according to any one of supplementary notes 12 to 21, further including, by the computer,
in the schedule acquisition processing, acquiring the schedule information of each of a plurality of the target persons, in which
the additional plan information includes information indicating the target person allowed to be in charge of the additional plan,
the method further including, by the computer,
in the plan addition processing:
causing a schedule indicated by the schedule information of each of the plurality of target persons, to be displayed in a screen;
determining a position where the additional plan is to be added in the screen, based on an operation performed by a user of the schedule management method; and
causing information indicating the target person allowed to be in charge of the additional plan, to be displayed in the screen.
   23. A program causing a computer to include:
a schedule acquisition function of acquiring schedule information of a target person;
an additional plan acquisition function of acquiring additional plan information indicating an additional plan to be added to the schedule information of the target person; and
a plan addition function of adding the additional plan to the schedule information by using the additional plan information, in which
the schedule information includes at least one piece of already set plan information indicating an already set plan to be performed by the target person,
the already set plan information includes a start time and an end time of the already set plan,
the additional plan information includes a start time and an end time of the additional plan, and,
when the already set plan and the additional plan overlap with each other on a time axis, the plan addition function changes the start time and the end time of the already set plan in such a way that the already set plan and the additional plan do not overlap with each other.
   24. The program according to supplementary note 23, in which
the already set plan information includes allowable time slot information indicating a time slot in which the already set plan is allowed to be set, and
the plan addition function changes the start time and the end time of the already set plan within the time slot indicated by the allowable time slot information.
   25. The program according to supplementary note 23, in which
the already set plan information includes first allowable time slot information indicating a time slot in which the already set plan is allowed to be set, and,
when at least one of the start time and the end time of the already set plan after change is outside the time slot indicated by the first allowable time slot information, the plan addition function outputs information having an indication thereof.
   26. The program according to supplementary note 24 or 25, in which
the plan addition function causes the time slot in which the already set plan is allowed to be set, to be displayed on a display.
   27. The program according to any one of supplementary notes 23 to 26, in which
the additional plan information includes second allowable time slot information indicating a time slot in which the additional plan is allowed to be set, and desired time slot information indicating a desired time slot of the additional plan, and
the plan addition function causes a schedule indicated by the schedule information to be displayed on a screen, and also causes each of the time slot indicated by the second allowable time slot information and the desired time slot, to be visually recognizable in the schedule.
   28. The program according to any one of supplementary notes 23 to 27, in which
the plan addition function
   causes a schedule indicated by the schedule information to be displayed on a screen, and
   causes the additional plan to be displayed in the screen in a mode different from that of the already set plan included in the schedule, and also causes the already set plan whose start time and end time have been changed, to be displayed in the screen in a mode different from that of a different already set plan.
      29. The program according to any one of supplementary notes 23 to 28, in which
the plan addition function
   causes a schedule indicated by the schedule information to be displayed on a screen,
   determines a position where the additional plan is to be added in the schedule within the screen, based on an operation performed by a user of the program, and
   decides whether to shift the already set plan to an earlier side or a later side, by using the position or a transition of the position, when the already set plan and the additional plan overlap with each other on a time axis.
      30. The program according to supplementary note 29, in which the operation is to drag and drop a mark indicating the additional plan, and,
when the already set plan and the additional plan overlap with each other on a time axis, the plan addition function
   shifts the already set plan to a later side when the mark enters before the already set plan, and
   shifts the already set plan to an earlier side when the mark enters after the already set plan.
      31. The program according to any one of supplementary notes 23 to 30, in which
the plan addition function provides a blank time having a predetermined length between the additional plan and the already set plan.
   32. The program according to supplementary note 31, in which
the plan addition function
   acquires detailed information indicating at least one of a location and an action, concerning at least one of the additional plan and the already set plan, and
   decides the predetermined length by using the detailed information.
      33. The program according to any one of supplementary notes 23 to 32, in which
the schedule acquisition function acquires the schedule information of each of a plurality of the target persons,
the additional plan information includes information indicating the target person allowed to be in charge of the additional plan, and
the plan addition function
   causes a schedule indicated by the schedule information of each of the plurality of target persons, to be displayed in a screen,
   determines a position where the additional plan is to be added in the screen, based on an operation performed by a user of the program, and
   causes information indicating the target person allowed to be in charge of the additional plan, to be displayed in the screen.

### REFERENCE SIGNS LIST

10 Schedule management apparatus
110 Schedule acquisition unit
120 Additional plan acquisition unit
130 Plan addition unit
140 Storage unit

What is claimed is:

1. A schedule management apparatus comprising:
at least one memory configured to store instructions; and
at least one processor configured to execute the instructions to perform operations comprising:
acquiring schedule information of a target person;
acquiring additional plan information indicating an additional plan to be added to the schedule information of the target person; and
adding the additional plan to the schedule information by using the additional plan information, wherein
the schedule information includes at least one piece of already set plan information indicating an already set plan to be performed by the target person,
the already set plan information includes a start time and an end time of the already set plan,
the additional plan information includes a start time and an end time of the additional plan, and,
the operations comprise, when the already set plan and the additional plan overlap with each other on a time axis, changing the start time and the end time of the already set plan in such a way that the already set plan and the additional plan do not overlap with each other.

2. The schedule management apparatus according to claim 1, wherein
the already set plan information includes allowable time slot information indicating a time slot in which the already set plan is allowed to be set, and
the operations further comprise changing the start time and the end time of the already set plan within the time slot indicated by the allowable time slot information.

3. The schedule management apparatus according to claim 1, wherein
the already set plan information includes first allowable time slot information indicating a time slot in which the already set plan is allowed to be set, and,
the operations further comprise, when at least one of the start time and the end time of the already set plan after change is outside the time slot indicated by the first allowable time slot information, outputting information having an indication thereof.

4. The schedule management apparatus according to claim 2, wherein
the operations further comprise causing the time slot in which the already set plan is allowed to be set, to be displayed on a display.

5. The schedule management apparatus according to claim 1, wherein
the additional plan information includes second allowable time slot information indicating a time slot in which the additional plan is allowed to be set, and desired time slot information indicating a desired time slot of the additional plan, and
the operations further comprise causing a schedule indicated by the schedule information to be displayed on a screen, and also causing each of the time slot indicated by the second allowable time slot information and the desired time slot, to be visually recognizable in the schedule.

6. The schedule management apparatus according to claim 1, wherein
the operations further comprise
causing a schedule indicated by the schedule information to be displayed on a screen, and
causing the additional plan to be displayed in the screen in a mode different from that of the already set plan included in the schedule, and also causing the already set plan whose start time and end time have been changed, to be displayed in the screen in a mode different from that of a different already set plan.

7. The schedule management apparatus according to claim 1, wherein
the operations further comprise
causing a schedule indicated by the schedule information to be displayed on a screen,
determining a position where the additional plan is to be added in the schedule within the screen, based on an operation performed by a user of the schedule management apparatus, and
deciding whether to shift the already set plan to an earlier side or a later side, by using the position or a transition of the position, when the already set plan and the additional plan overlap with each other on a time axis.

8. The schedule management apparatus according to claim 7, wherein
the operation is to drag and drop a mark indicating the additional plan, and,
the operations further comprise, when the already set plan and the additional plan overlap with each other on a time axis,
shifting the already set plan to a later side when the mark enters before the already set plan, and
shifting the already set plan to an earlier side when the mark enters after the already set plan.

9. The schedule management apparatus according to claim 1, wherein
the operations further comprise providing a blank time having a predetermined length between the additional plan and the already set plan.

10. The schedule management apparatus according to claim 9, wherein
the operations further comprise
acquiring detailed information indicating at least one of a location and an action, concerning at least one of the additional plan and the already set plan, and
deciding the predetermined length by using the detailed information.

11. The schedule management apparatus according to claim 1, wherein
the operations further comprise acquiring the schedule information of each of a plurality of the target persons,
the additional plan information includes information indicating the target person allowed to be in charge of the additional plan, and
the operations further comprise
causing a schedule indicated by the schedule information of each of the plurality of target persons, to be displayed in a screen,
determining a position where the additional plan is to be added in the screen, based on an operation performed by a user of the schedule management apparatus, and
causing information indicating the target person allowed to be in charge of the additional plan, to be displayed in the screen.

12. A schedule management method comprising,
by a computer, performing:
schedule acquisition processing of acquiring schedule information of a target person;
additional plan acquisition processing of acquiring additional plan information indicating an additional plan to be added to the schedule information of the target person; and
plan addition processing of adding the additional plan to the schedule information by using the additional plan information, wherein
the schedule information includes at least one piece of already set plan information indicating an already set plan to be performed by the target person,
the already set plan information includes a start time and an end time of the already set plan, and
the additional plan information includes a start time and an end time of the additional plan,
the method further comprising, by the computer,
in the plan addition processing, when the already set plan and the additional plan overlap with each other on a time axis, changing the start time and the end time of the already set plan in such a way that the already set plan and the additional plan do not overlap with each other.

13. A non-transitory computer-readable medium storing a program for causing a computer to perform operations comprising:
acquiring schedule information of a target person;
acquiring additional plan information indicating an additional plan to be added to the schedule information of the target person; and
adding the additional plan to the schedule information by using the additional plan information, wherein
the schedule information includes at least one piece of already set plan information indicating an already set plan to be performed by the target person,
the already set plan information includes a start time and an end time of the already set plan,
the additional plan information includes a start time and an end time of the additional plan, and,
the operations comprise, when the already set plan and the additional plan overlap with each other on a time axis, changing the start time and the end time of the already set plan in such a way that the already set plan and the additional plan do not overlap with each other.
